(19) United States
(12) Patent Application Publication
(10) Pub. No.: US 2018/0355931 A1
(43) Pub. Date: Dec. 13, 2018

(54) BRAKE PAD MOUNTING, BRAKE PAD AND PAD HOLDER

(71) Applicant: KNORR-BREMSE SYSTEME FÜR SCHIENENFAHRZEUGE GMBH, München (DE)

(72) Inventors: Marc-Gregory ELSTORPFF, München (DE); Michael MATHIEU, Puchheim (DE); Marco LANGWADT, München (DE); Alexander JUNG, Gauting (DE); Erich FUDERER, Fürstenfeldbruck (DE)

(21) Appl. No.: 15/539,441

(22) PCT Filed: Dec. 17, 2015
(86) PCT No.: PCT/EP2015/080124

§ 371 Date: Jun. 23, 2017

(30) Foreign Application Priority Data
Dec. 23, 2014 (DE) 10 2014 119 492.6

(51) Int. Cl. F16D 65/095; B61H 5/00

(52) U.S. Cl. CPC F16D 65/095; F16D 2200/0004; B61H 5/00

(57) ABSTRACT

A brake pad mounting of a brake pad of a disc brake of a rail vehicle on a pad holder of the disc brake is described, wherein the pad holder has a holder plate and at least one locking element for securing the pad carrier on the holder plate, the brake pad has a pad carrier plate and at least one pad element arranged thereon, in the mounted position of the brake pad on the pad holder the pad carrier plate is held on the pad holder in a form-fitting manner, wherein border-side embracing webs which extend in the direction of the pad carrier plate and have grooves open with respect to the surface centre of the holder plate are integrally formed on the holder plate. A brake pad and a pad holder are furthermore described.

### CROSS REFERENCE AND PRIORITY CLAIM

This patent application is a U.S. National Phase of International Patent Application No. PCT/EP2015/080124, filed 17 Dec. 2015, which claims priority to German Patent Application No. 102014119492.6, filed 23 Dec. 2014, the disclosures of which are incorporated herein by reference in their entirety.

### FIELD

Disclosed embodiments relate to a brake pad mounting of a brake pad of a disk brake of a rail vehicle on a pad holder of the disk brake, and to a brake pad and to a pad holder.

A generic brake pad mounting of a brake pad of a disk brake of a rail vehicle is known for example from EP 0 837 260 A1. In that case, a pad carrier plate of the brake pad has an engaging part which engages around the rims of the pad holder on both sides.

In the pad holder, a locking bolt is furthermore provided on a side remote from the brake pad, the locking bolt engaging in a bore in the pad carrier plate of the brake pad through a bore in the pad holder plate and thus holding the brake pad in a form-fitting manner in all directions. In order to mount the brake pad, the pad carrier plate has to be guided over the pad holder plate of the pad holder in the circumferential direction of a brake disk of the disk brake. In order to integrally form such an engaging part on a pad carrier plate, the pad carrier plate of the brake pad, and also the pad holder itself, is embodied as a cast part.

It is disadvantageous that extensively machined cast parts such as the pad carrier plate, frequently suffer distortion making it difficult to manufacture the pad carrier plate and resulting in associated pad carrier plate rejects. Since the entire surface of both sides of the pad carrier plate has to be machined, the machining effort in the case of these pad carrier plates produced as cast parts is relatively large.

### SUMMARY

Disclosed embodiments provide a brake pad mounting of a brake pad of a disk brake of a rail vehicle on a pad holder of the disk brake such that the brake pad is held on the pad holder securely and in a form-fitting manner, wherein the transmission of all of the forces that occur is possible as well as the ability to change a brake pad easily and without problems, taking the available installation space into consideration.

### BRIEF DESCRIPTION OF THE FIGURES

Embodiment variants are explained in more detail in the following text with reference to the accompanying drawings, in which:

FIG. 1 shows a perspective view of a disclosed embodiment variant of a brake pad mounting according to the invention,

FIG. 2 shows a side view of the brake pad mounting from FIG. 1 in a radial viewing direction,

FIG. 3 shows a side view of the brake pad mounting from FIG. 1 in the circumferential direction with a chamfered groove,

FIG. 4 shows a side view of the brake pad mounting from FIG. 1 in the circumferential direction with a groove formed in a square manner,

FIG. 5 shows a perspective view of a pad carrier plate of the brake pad with peripheral regions with a reduced plate thickness,

FIG. 6 shows a perspective view of an embodiment variant of a pad holder with peripheral engaging bars that extend in the direction of the pad carrier plate,

FIG. 7 shows a view from below of the brake pad mounting from FIG. 1 with the pad elements being illustrated,

FIG. 8 shows a perspective view of an alternative embodiment variant of a brake pad with a single pad element, and

FIG. 9 shows a sectional view of the brake pad shown in FIG. 8.

### DETAILED DESCRIPTION

In the brake pad mounting according to the invention, in which a pad holder has a holder plate and at least one locking element for securing the pad carrier to the holder plate, and the brake pad has a pad carrier plate and at least one pad element arranged on the latter, and the pad carrier plate is held on the pad holder in a form-fitting manner in the mounted state of the brake pad on the pad holder, peripheral engaging bars that extend in the direction of the pad carrier plate and have grooves that are open toward the center of the holder plate are integrally formed on the holder plate.

This allows much easier machining of the carrier plate, since only bores, countersinks and machining of the peripheral regions of the pad carrier plate are still necessary, but extensive machining of the pad carrier plate is not.

Disclosed embodiments of a brake pad of a disk brake of a rail vehicle is distinguished by the fact that peripheral regions of the pad carrier plate with a reduced plate thickness are configured to be received in grooves in engaging bars of a holder plate of a pad holder of the disk brake.

The pad holder of a disk brake of a rail vehicle is distinguished by the fact that peripheral engaging bars that extend in the direction of the pad carrier plate and have grooves that are open toward the center of the holder plate are integrally formed on the holder plate, peripheral regions of the pad carrier plate with a reduced plate thickness being receivable in the grooves.

The pad carrier plate, formed in such a way, of the brake pad is able to be clamped for example on a magnetic clamping plate as a result, with the result that a short machining time and a low reject rate are achievable.

According to one embodiment variant, peripheral regions of the pad carrier plate are formed with a reduced plate thickness. The peripheral regions of the pad carrier plate with a reduced plate thickness may be received in the grooves in the engaging bars of the holder plate.

As a result, the engaging bars of the holder plate can be formed in a shorter manner than in the design known from the prior art, in which the engaging bars may be integrally formed on the pad carrier plate and have to engage around the holder plate. This installation space that is additionally available as a result is available, for example, for an increase in friction pad thickness.

According to one embodiment variant, the engaging bars of the holder plate of the pad holder do not protrude over that face of the pad carrier plate that faces the at least one pad element. This makes it possible for the movability of the pad elements of the brake pad that protrude over the rim of the pad carrier plate not to be limited.

The peripheral regions of the pad carrier plate with a reduced plate thickness are in the form of milling grooves according to a further advantageous embodiment variant.

In this case, the pad carrier plate may be manufactured as a sheet-metal part cut out of a rolled metal sheet, this being associated with a reduction in costs, both in terms of the material selection and in terms of the easy machining of a pad carrier plate formed in such a way, compared with the carrier plates otherwise embodied as a cast part.

In this case, the peripheral regions of the pad carrier plate may be formed in a stepped or chamfered manner. In a corresponding manner, the grooves of the holder plate are in the form of square grooves or are formed such that at least one of the inner faces of the grooves is formed in a chamfered manner.

Such designs of the engaging bars and the peripheral regions of the pad carrier plate are able to be introduced easily as a cast part (holder plate) and on a pad carrier plate manufactured from rolled sheet metal, respectively.

In the following description of the figures, terms such as top, bottom, left, right, front, rear etc. refer exclusively to the exemplary illustration and position, selected in the respective figures, of the brake pad mounting, pad holder, holder plate, brake pad, pad carrier plate, pad elements and the like. These terms should not be understood in a limiting manner, i.e. these references can change as a result of different working positions or the mirror-symmetrical design or the like.

The “radial” direction should always be understood here as being a direction of the brake pad mounting, pad holder, holder plate, brake pad, pad carrier plate, pad elements or the like in the state installed in a disk brake radially with respect to an axis of rotation of a brake disk (not illustrated) of the disk brake.

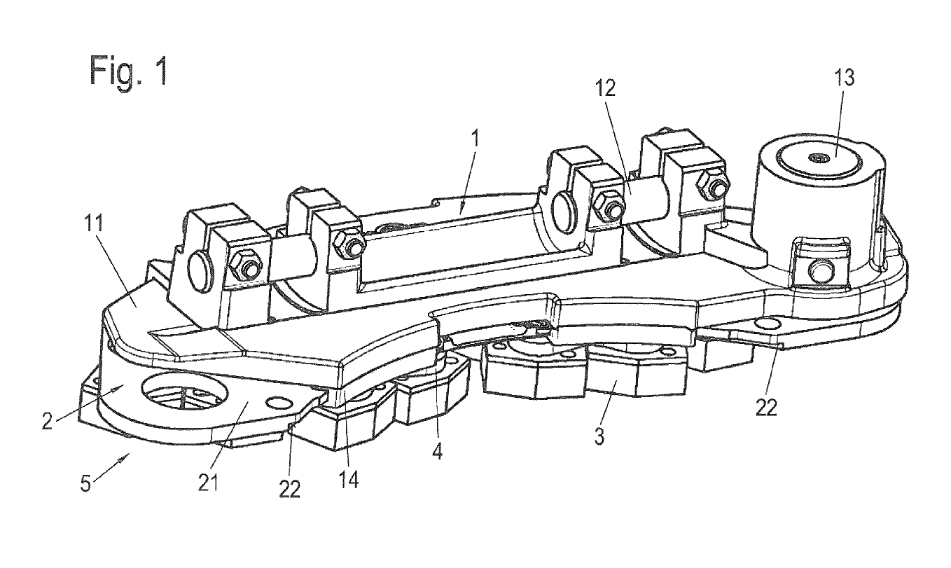

FIG. 1 shows a perspective illustration of an embodiment variant of a brake pad mounting according to a disclosed embodiment.

In this case, a pad holder 1 has a holder plate 11 and at least one locking element 13 for securing a pad carrier 2 of a brake pad 5 to the holder plate 11. Furthermore, two pad holder bolts 12 are shown on the top side of the pad holder 1, the pad holder 1 being secured to a brake application device of the disk brake via the bolts.

The locking element 13 is in this case optionally in the form of a locking bolt which is received in a cylindrical mount of the pad holder 1 and is mounted by way of a bore 16 in the pad holder plate 11 and a bore 24 in the pad carrier plate 2 of the brake pad 5, thereby securing the pad carrier plate 2 in a form-fitting manner against displacement in or counter to the direction of rotation of a brake disk (not illustrated) of the disk brake.

A brake pad 5 is mounted on a side of the holder plate 11 of the pad holder 1 that is remote from the pad holder bolt 12.

In this case, the brake pad 5 has a pad carrier plate 2 and at least one pad element 3 that is arranged, in particular mounted thereon, the pad element 3 having the actual friction pad 31 on its side remote from the pad carrier plate 2, the friction pad 31 being fastened to a carrier element 32 of the pad element 3.

According to an embodiment variant, a multiplicity of pad elements 3 are arranged on the pad carrier plate 2. Thus, in the embodiment variant shown in FIGS. 1 to 4 and 7, a plurality of group elements that are formed from in each case one carrier sheet 4 and a plurality of pad elements 3 arranged, in particular mounted thereon are arranged on the pad carrier plate 2.

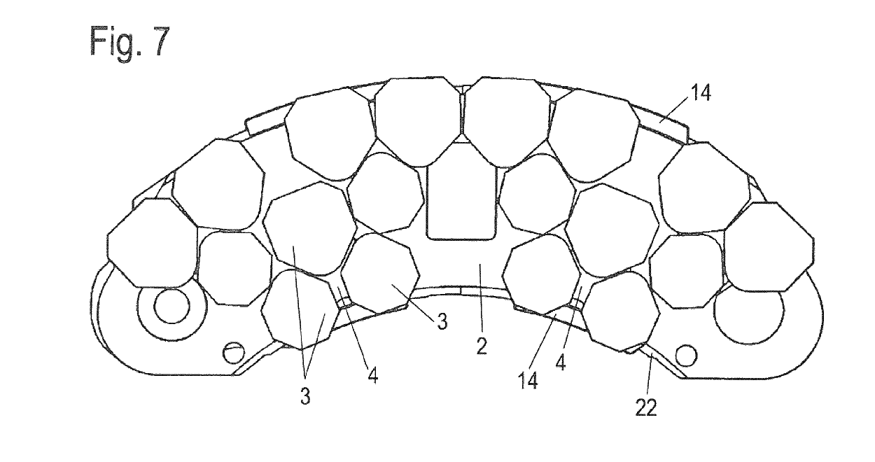

In this case, each of these group elements optionally has in each case three pad elements 3. As shown in FIG. 7, three pad elements 3 are mounted in this case on each of the carrier sheets 4. In this case, in each case two of the pad elements 3 have a friction surface of equal size such that, when a brake application force is distributed over the individual pad elements 3 of a carrier sheet 4, surface pressures of different magnitude arise with an equally distributed brake application force, wherein radially internal pad elements 3 have smaller friction surfaces than the friction surfaces of pad elements 3 that are radially external with respect to the axis of rotation of the brake disk, in order to keep the rate of wear of the individual pad elements 3 as equal as possible.

The pad elements 3 optionally have bearing elements 33 that are arranged, in particular integrally formed on the carrier elements 32 for spherical mounting, in particular in the form of spherical caps, which are mounted in spherical recesses, optionally in the form of ball sockets, in the carrier sheets 4.

The carrier sheets 4 are optionally mounted in a corresponding manner in spherical recesses 25 in the pad carrier plate 2.

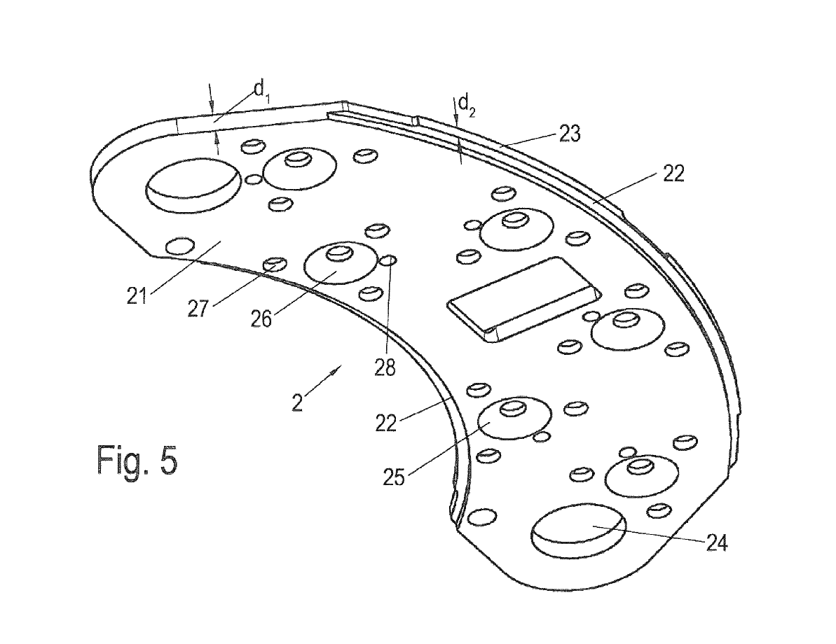

To this end, as can be seen in FIG. 5, spherically shaped recesses 25 are provided in the central region 21 of the pad carrier plate 2, and bores 27 for receiving bearing elements 33 of the individual pad elements 3.

In addition to the mounting of the pad elements 3 on the carrier sheets 4 and the mounting of the carrier sheets 4 on the pad carrier plate 2, it is also conceivable in principle to arrange the pad elements 3 on the carrier sheets 4 and the carrier sheets 4 on the pad carrier plate 2, for example firmly attach them thereto.

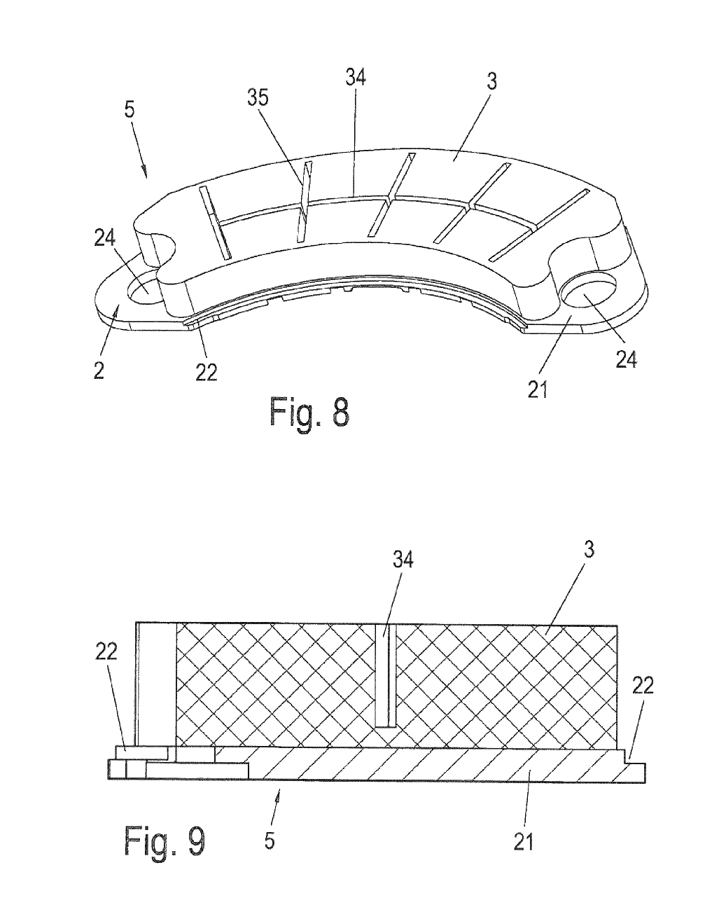

According to an alternative embodiment variant, shown in FIGS. 8 and 9, a single pad element 3 is arranged on the pad carrier plate 2. The friction surface of this pad element 3 is accordingly much larger than the pad elements 3 of the pad elements 3 shown in FIGS. 1 to 4 and 7. The pad element 3 is in this case secured directly to the pad carrier plate 2. A carrier sheet 4, as is shown in the embodiment variant according to FIGS. 1 to 7, is not provided in this embodiment variant.

The pad element 3 may have slot-like recesses 34, 35 which are open toward the side remote from the pad carrier plate 2. A first slot 34 may extend along a circular curve, wherein the center of a circle of this circular curve corresponds to the center of rotation of the brake disk of the disk brake. The first slot 34 may be intersected by a plurality of second slots 35 that cross the first slot 34 perpendicularly thereto and are optionally at equal spacings from one another in the region of the crossing points. The slot depth of the slots 34, 35 is in this case optionally between 75% and 90% of the initial friction pad thickness of the pad element 3.

The mounting of the pad carrier plate 2 on the holder plate 11 of the pad holder 1 furthermore takes place via peripheral engaging bars 14 that extend in the direction of the pad carrier plate 2 and have grooves 15 that are open toward the center of the holder plate 11, as can readily be seen in FIGS. 1, 3 and 4.

In this case, peripheral regions 23 of the pad carrier plate 2 are formed with a reduced plate thickness d₂. Optionally, the thickness d₂ of the peripheral regions 23 of the pad carrier plate 2 is about 40% to 60% of the thickness d₁ of the central region 21 of the pad carrier plate 2.

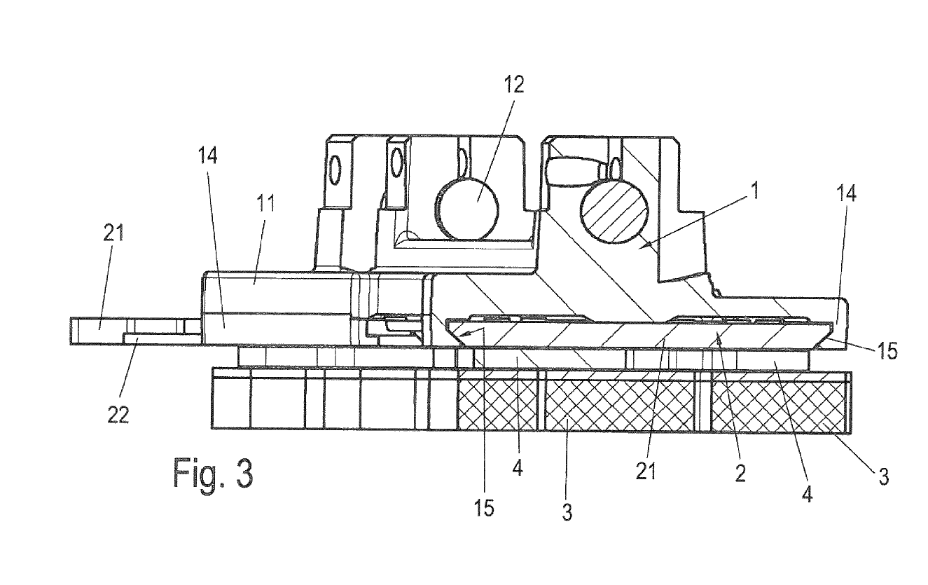

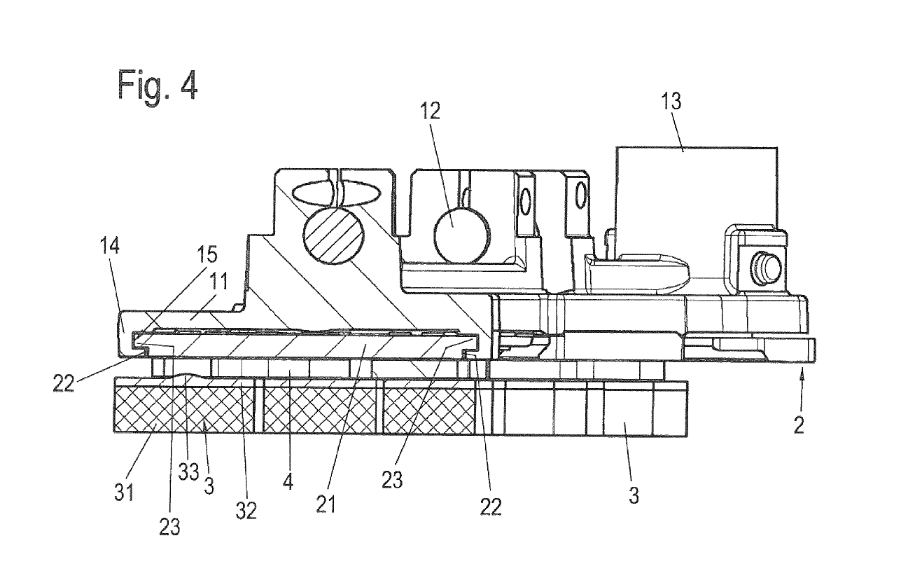

As can be readily seen in FIGS. 3 and 4, the peripheral regions 23 of the pad carrier plate 2 with a reduced plate thickness d₂ are received in the grooves 15 in the engaging bars 14 of the holder plate 11.

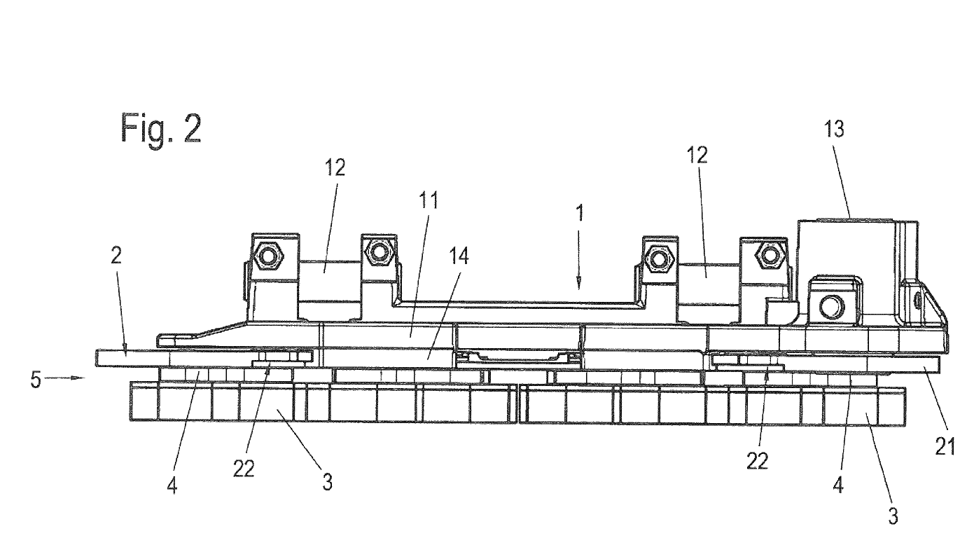

The engaging bars 14 are optionally shaped such that they do not protrude over that face of the pad carrier plate 2 that faces the at least one pad element 3, but end flush therewith, as is shown for example in FIG. 2.

Accordingly, the thickness d₁ of the central, unmilled region 21 of the pad carrier plate 2 optionally corresponds to the extent of the engaging bars 14 from the pad holder plate 11 in the direction of the pad carrier plate 2.

These peripheral regions 23 of the pad carrier plate 2 with a reduced plate thickness d₂ are in this case optionally introduced by making a milling groove in the material of the pad carrier plate 2.

The pad carrier plate 2 is in this case optionally in the form of a sheet-metal part, in particular of a sheet-metal part cut out of a rolled metal sheet.

The engaging bars 14 are in this case formed on lateral rims of the holder plate 11 that extend in the circumferential direction of the brake disk of the disk brake.

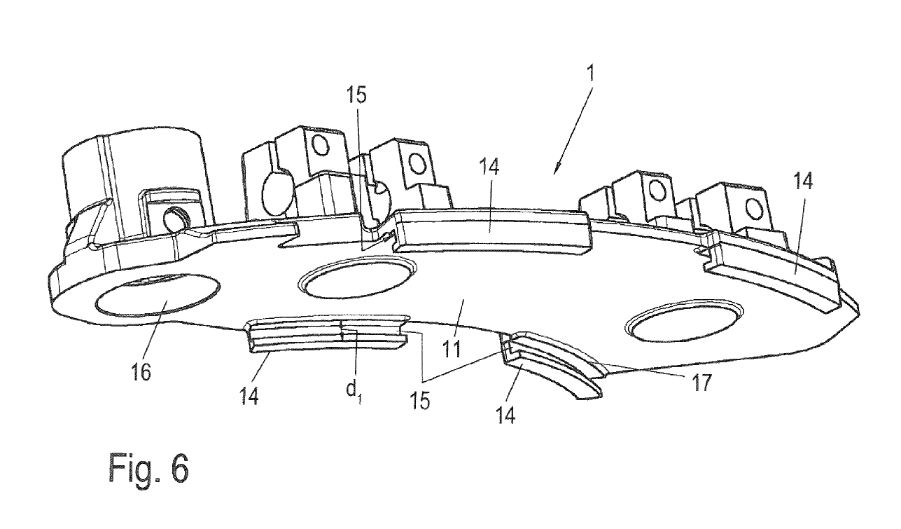

In this case, as can be seen particularly readily in FIG. 6, two such engaging bars 14 are formed on each of the lateral rims of the holder plate 11 that extend in the circumferential direction of the brake disk of the disk brake.

However, it is also conceivable to integrally form only one engaging bar 14 per lateral rim or more than two engaging bars 14 per lateral rim.

In order to prevent direct contact of that side of the pad carrier plate 2 that faces the holder plate 11 with the holder plate 11, those bearing surfaces of the engaging bars 14 that are close to the surface of the holder plate 11 are configured as elevations 17.

According to an advantageous embodiment variant shown in FIG. 3, the design of the grooves 14 in the engaging bars 14 is such that at least one of the inner faces of the grooves is formed in a chamfered manner.

In a corresponding manner, that bearing surface of the peripheral regions 23 of the pad carrier plate 2 that bears against the chamfered inner face of the grooves 15 is formed in a chamfered manner, such that the two mutually facing sliding surfaces in the grooves 15 and in the peripheral regions 23 of the pad carrier plate 2 rest against one another.

In the alternative embodiment variant shown in FIG. 4, the grooves 15 are in the form of square grooves and the peripheral regions 23 of the pad carrier plate 2 are formed in a stepped manner, wherein the pad carrier plate 2 with a thickness d₁ narrows toward the peripheral region 23 via a step 22.

The thickness d₂ of the peripheral region 23 is in this case slightly less than the groove width d₃ of the engaging bars 14, such that, when the brake pad is mounted on the holder plate 11 of the pad holder 1, the pad carrier plate 2 can be pushed into the grooves 15 in the engaging bars 14 in the circumferential direction of the brake disk.

In a corresponding manner, the engaging bars 14 and the lateral rims 23 of the pad carrier plate 2 are optionally shaped in the form of a circular arc.

### LIST OF REFERENCE SIGNS

1 Pad holder
11 Holder plate
12 Pad holder bolt
13 Locking element
14 Engaging bar
15 Groove
16 Bore
17 Elevation
2 Pad carrier plate
21 Central region
22 Milling groove
23 Peripheral region
24 Bore
25 Spherical recess
26 Spherical recess
27 Bore
28 Bore
3 Pad element
31 Friction pad
32 Carrier element
33 Bearing element
34 Slot
35 Slot
4 Carrier sheet
5 Brake pad
d₁ Plate thickness
d₂ Reduced plate thickness
d₃ Groove width of the engaging bars

1. A brake pad mounting for a brake pad of a disk brake of a rail vehicle on a pad holder of the disk brake, wherein
the pad holder has a holder plate and at least one locking element for securing the pad carrier to the holder plate,
the brake pad has a pad carrier plate and at least one pad element arranged on the latter,
the pad carrier plate is held on the pad holder in a form-fitting manner in the mounted state of the brake pad on the pad holder, and
the brake pad mounting includes peripheral engaging bars that extend in the direction of the pad carrier plate and have grooves that are open toward the center of the holder plate and are integrally formed on the holder plate.

2. The brake pad mounting of claim 1, wherein peripheral regions of the pad carrier plate are formed with a reduced plate thickness (d₂).

3. The brake pad mounting of claim 2, wherein the peripheral regions of the pad carrier plate with a reduced plate thickness (d₂) are received in the grooves in the engaging bars of the holder plate.

4. The brake pad mounting of claim 1, wherein the engaging bars do not protrude over that face of the pad carrier plate that faces the at least one pad element.

5. The brake pad mounting of claim 2, wherein the peripheral regions of the pad carrier plate with a reduced plate thickness (d₂) are of milling grooves.

6. The brake pad mounting of claim 1, wherein the engaging bars are formed on lateral rims of the holder plate that extend in the circumferential direction of a brake disk of the disk brake.

7. The brake pad mounting of claim 6, wherein at least one engaging bar is formed on each of the lateral rims of the holder plate that extend in the circumferential direction of the brake disk of the disk brake.

8. The brake pad mounting of claim 7, wherein two spaced-apart engaging bars are formed on each of the lateral rims of the holder plate that extend in the circumferential direction of the brake disk of the disk brake.

9. The brake pad mounting of claim 1, wherein the grooves are square grooves and the peripheral regions of the pad carrier plate are stepped.

10. The brake pad mounting of claim 1, wherein at least one of the inner faces of the grooves is formed in a chamfered manner and accordingly the bearing surface of the peripheral regions of the pad carrier plate that bears against the chamfered inner face of the grooves is chamfered.

11. The brake pad mounting of claim 1, wherein the pad carrier plate is a rolled piece of sheet metal.

12. A brake pad of a disk brake of a rail vehicle, the brake pad comprising:
a pad carrier plate and
at least one pad element arranged on the latter,
wherein, peripheral regions of the pad carrier plate with a reduced plate thickness (d₂) are configured to be received in grooves in engaging bars of a holder plate of a pad holder of the disk brake.

13. The brake pad of claim 12, wherein the peripheral regions of the pad carrier plate with a reduced plate thickness (d₂) are milling grooves.

14. The brake pad of claim 12, wherein the peripheral regions of the pad carrier plate are stepped or chamfered.

15. The brake pad of claim 12, wherein the pad carrier plate is a rolled piece of sheet metal.

16. The brake pad of claim 12, wherein a plurality of pad elements (3) are arranged on the pad carrier plate.

17. The brake pad of claim 16, wherein a plurality of group elements each formed from a carrier sheet and a plurality of pad elements arranged on the latter are arranged on the pad carrier plate.

18. The brake pad of claim 12, wherein exactly one pad element is arranged on the pad carrier plate.

19. A pad holder of a disk brake of a rail vehicle, the pad holder comprising:
a holder plate (11); and
at least one locking element for securing a pad carrier of the disk brake to the holder plate,
wherein
peripheral engaging bars that extend in the direction of the pad carrier plate and have grooves that are open toward the center of the holder plate are integrally formed on the holder plate, peripheral regions of the pad carrier plate being receivable in said grooves.

20. The pad holder of claim 17, wherein the engaging bars are formed on lateral rims of the holder plate that extend in the circumferential direction of a brake disk of the disk brake.

21. The pad holder of claim 20, wherein at least one engaging bar is formed on each of the lateral rims of the holder plate that extend in the circumferential direction of the brake disk of the disk brake.

22. The pad holder of claim 21, wherein two spaced-apart engaging bars are formed on each of the lateral rims of the holder plate that extend in the circumferential direction of the brake disk of the disk brake.

23. The pad holder of claim 19, wherein the grooves are square grooves or at least one of the inner faces of the grooves is a chamfered.
